(19) United States
(12) Patent Application Publication
(10) Pub. No.: US 2009/0220094 A1
(43) Pub. Date: Sep. 3, 2009

(54) PROCESSING CIRCUIT CAPABLE OF MODIFYING DIGITAL AUDIO SIGNALS

(76) Inventor: Tzueng-Yau Lin, Tai-Chung Hsien (TW)

Correspondence Address: NORTH AMERICA INTELLECTUAL PROPERTY CORPORATION, P.O. BOX 506, MERRIFIELD, VA, 22116, US

(21) Appl. No.: 12/463,424

(22) Filed: May 11, 2009

Related U.S. Application Data
(62) Division of application No. 10/707,858, filed on Jan. 19, 2004.

(30) Foreign Application Priority Data
Jan. 20, 2003 (TW) 092101066

(51) Int. Cl. H04H 40/36

(52) U.S. Cl. 381/2

(57) ABSTRACT

The present invention provides an audio processing circuit for receiving a first stream complying with a first standard (for example. MPEG audio standard) and generating a second stream complying with a second standard which is a digital interface standard (for example, S/PDIF standard). The audio processing circuit includes: a stream buffer for storing a plurality of frames of the first stream; a stream recovering circuit for detecting at least one of a plurality of fields in the frames, modifying at least one of the plurality of fields according to the first standard, and generating modified frames; a first buffer for storing the modified frames; and a burst circuit for partitioning the modified frames into a plurality of payload sections, adding a preamble to each of the payload sections, and forming the second stream.

### CROSS REFERENCE TO RELATED APPLICATIONS

This application is a division of U.S. application Ser. No. 10/707,858 filed Jan. 19, 2004, and incorporated herein by reference in its entirety.

### BACKGROUND OF THE INVENTION

1. Field of the Invention

The present invention relates to an audio processing circuit, and more particularly, to an audio processing circuit capable of modifying digital audio signals that are appropriate for transmitting to other digital audio systems.

2. Description of the Prior Art

FIG. 1 illustrates the format of a stream according to the IEC 60958 standard. In the IEC 61937 standard, an interface format is defined for non-linear pulse-code modulation (PCM) encoded audio streams using the IEC 60958 standard. This IEC digital interface standard is also called S/PDIF (Sony/Philips Digital Interface). The IEC digital interface standard can be used for transmitting non-linear pulse-code modulation samples, and also can be used for transmitting data. Each encoded audio stream includes a plurality of S/PDIF frames. Each S/PDIF frame includes S/PDIF subframes such as a data burst section and a stuffing section having several stuffing bits. The length of the data burst section varies, and the stuffing section keeps the length of the S/PDIF frame constant. Each data burst section includes a preamble and a payload section. The preamble includes header information Pa, Pb, Pc, and Pd. Pa and Pb represent synchronization words of the S/PDIF standard. Pc represents the burst information. The payload section contains the information of an encoded audio frame of the encoded audio stream, and has several fields such as sync word, header, side information, audio samples, ancillary data, etc.

FIG. 2 illustrates a block diagram of an audio processing circuit 10 of an optical disk drive in the prior art. The audio processing circuit 10 includes a parser 12, a stream buffer 14, an audio processor 16, a second buffer 18, a digital to analog converter 20, an IEC burst circuit 22, and a digital interface 24. Digital data recorded on the optical storage disk 26 is retrieved and preliminarily processed by a servo controller (which is not shown in FIG. 2), is then sent to the parser 12. The parser 12 parses the digital data, and passes the digital audio signals to the stream buffer 14 in a form of an audio stream. The audio stream includes a plurality of audio frames. The audio processor 16 decodes the audio frames stored in the stream buffer 14. The decoded information is then stored in the second buffer 18. Finally, the digital to analog converter 20 converts the decoded information stored in the second buffer 18 into an analog signal as an output signal of the optical disk drive. As the user probably desires using an external decoding/amplifying device (ex. the post-stage audio receiver 28 illustrated in FIG. 2) for digital audio signal processing rather than using the internal audio processing circuit 10 incorporated inside the optical disk drive, the audio processing circuit 10 of the optical disk drive generally provides not only the above-mentioned decoding apparatus for reproducing the analog audio data which is digitally recorded on the optical storage disk 26 but also an digital interface 24 for connecting the optical disk drive to a post-stage audio receiver 28. As mentioned, the digital data recorded on the optical storage disk 26 received by the parser 12 is sent to the stream buffer 14 in the form of the audio stream and stored in the stream buffer 14. The audio frames of the audio stream stored in the stream buffer 14 can be decoded as mentioned or transferred into a S/PDIF stream, a stream of IEC 61937/IEC 60958 standard, and the S/PDIF stream is then sent from the digital interface 24 to the external post-stage audio receiver 28. The IEC burst circuit 22 in FIG. 2 retrieves the audio frames stored in the stream buffer 14 and partitions the audio frames into payload sections of proper sizes. As shown in FIG. 1, the corresponding preamble is added in front of each payload to form a data burst section, and the corresponding stuffing section is then added next to each data burst section. The transferred stream complying with the S/PDIF standard is then formed and sent to the post-stage audio receiver 28 through the digital interface 24.

As mentioned above, the audio frames derived from the digital data on the optical storage disk 26 is stored in the stream buffer 14, and the audio frames stored in the stream buffer 14 can be decoded by the audio processor 16. The decoded information is then stored in the second buffer 18, and the digital to analog converter 20 converts the decoded information into an analog signal as the output signal of the optical disk drive. In addition, the optical disk drive can be connected to the post-stage audio receiver 28 through the digital interface 24, which is an interface for outputting the transferred signal generated by the IEC burst circuit 22 into the post-stage audio receiver 28. However, in the prior art the IEC burst circuit 22 simply transfers the digital audio data of the audio frames stored in the bit stream buffer 14 without checking the correctness of the digital audio data. If the digital audio data extracted from the stream buffer 14 does not completely comply with a predetermined digital audio standard such as MPEG audio standard, the post-stage audio receiver 28 may fail to properly decode the received digital data. For example, some MPEG audio bit streams are encoded by improper audio signal encoding softwares or hardwares, and do not strictly follow the MPEG audio standard. In the prior art such audio bit streams would be output to the post-stage audio receiver 28 through the digital interface 24 without any error-check, and the post-stage audio receiver 28 may fail to decode them properly and thus unpleasant blast sound may occur.

Some technical background information is disclosed in several US patents, including U.S. Pat. Nos. 5,794,181, 5,884,048, 6,122,619, 6,128,579, and 6,272,153.

### SUMMARY OF THE INVENTION

It is therefore an objective of the present invention to provide an apparatus and a method for modifying digital audio signals to solve the above-mentioned problem.

The present invention provides an audio processing circuit for receiving a first stream complying with a first standard and generating a second stream complying with a second standard which is a digital interface standard, the first stream includes a plurality of frames, each of the frames includes a plurality of fields, the audio processing circuit comprises a stream buffer, a stream recovering circuit, and a digital interface. The stream buffer stores the frames of the first stream. The stream recovering circuit electrically connected to the stream buffer receives the first stream having a mode field, the candidate values of the mode field in the first standard at least comprising a dual mono mode and a stereo mode, and for processing the first stream to generate the second stream so that the mode field of the second stream is the stereo mode value if the mode field of the first stream contains the dual mono mode value. The digital interface outputs the second stream to a post-stage audio receiver.

The present invention further provides a method for converting a first stream complying with a first standard into a second stream complying with a second standard which is a digital interface standard, the first stream includes a plurality of frames, each of the frames includes a plurality of fields, the method comprises the steps of: receiving the first stream having a mode field with a stream recovering circuit, the candidate values of the mode field in the first standard at least comprising a dual mono mode and a stereo mode; processing the first stream to generate the second stream with the stream recovering circuit so that the mode field of the second stream is the stereo mode value if the mode field of the first stream contains the dual mono mode value; and outputting the second stream with a digital interface to a post-stage audio receiver.

The present invention further provides an optical disk drive, comprising a parser, a stream buffer, a stream recovering circuit, and a digital interface. The parser parses a first stream from an optical disk. The stream buffer stores frames of the first stream. The stream recovering circuit electrically connected to the stream buffer receives the first stream having a mode field, the candidate values of the mode field in the first standard at least comprising a dual mono mode and a stereo mode, and for processing the first stream to generate a second stream so that the mode field of the second stream is the stereo mode value if the mode field of the first stream contains the dual mono mode value, the second stream being a digital interface standard. The digital interface outputs the second stream to a post-stage audio receiver.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a data format diagram of S/PDIF standard, which is the prior art.

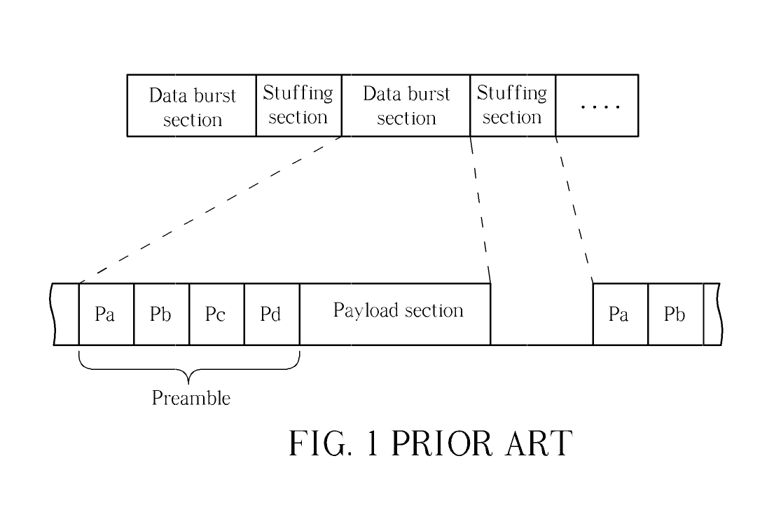

FIG. 2 is a block diagram of an audio processing circuit for an optical disk drive according to the prior art.

FIG. 3 is a block diagram of an audio processing circuit for an optical disk drive according to one embodiment of the present invention.

FIG. 4 is a flowchart of detecting and modifying streams with the audio processing circuit of FIG. 3.

FIG. 5 is a flowchart of changing a field of a stream with the audio processing circuit of FIG. 3.

FIG. 6 is a flowchart of detecting and modifying errors in at least one field of a frame in a stream with the audio processing circuit of FIG. 3.

### DETAILED DESCRIPTION

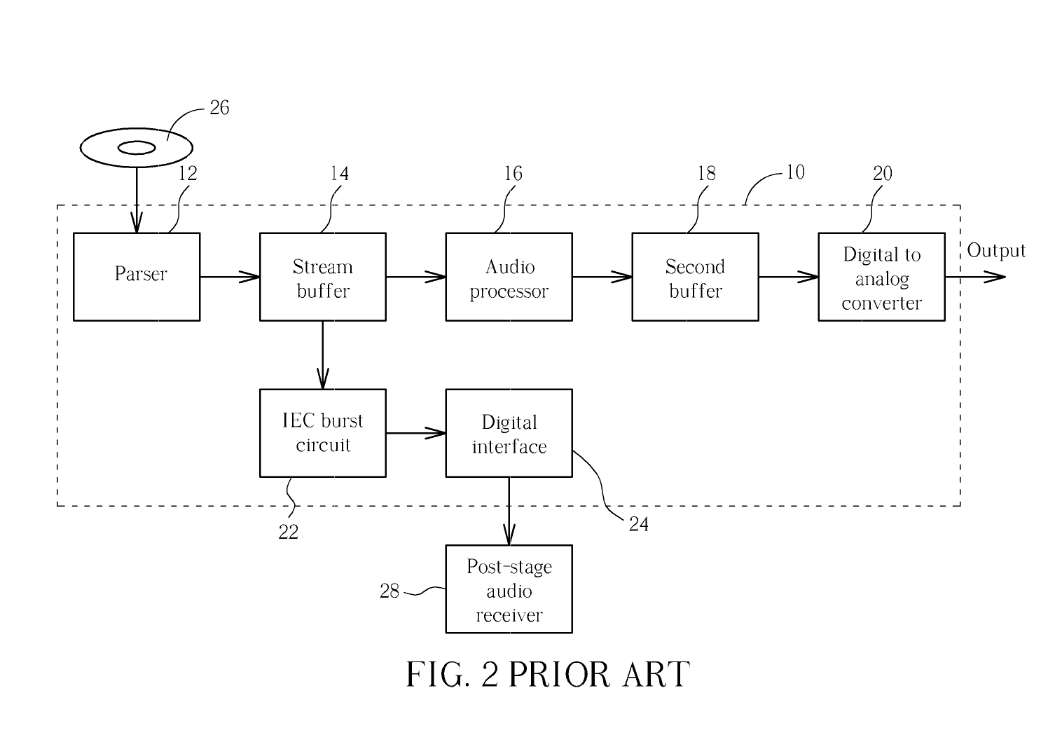

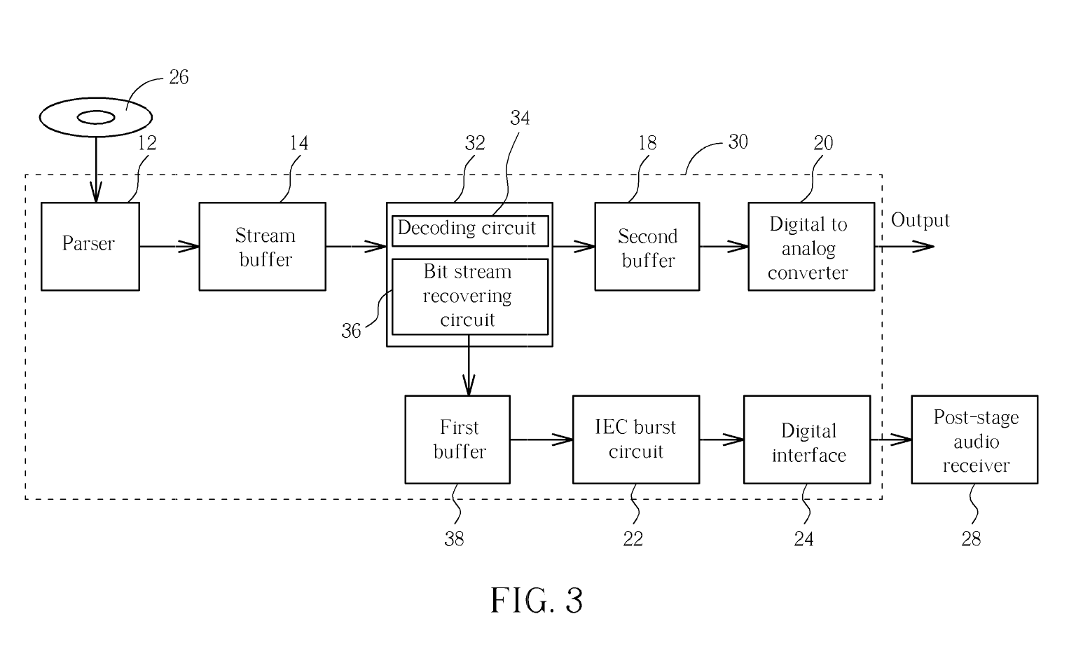

FIG. 3 illustrates a block diagram of an audio processing circuit 30 of an optical storage device such as an optical disk drive according to one embodiment of the present invention. To easily compare the embodiment with the prior art, some of the elements in FIG. 3 are labeled with the same numbers used in FIG. 2. An element in FIG. 3 labeled with a previously used number in FIG. 2 has the same functionality as that of the corresponding element in FIG. 2. The audio processing circuit 30 includes a parser 12, a stream buffer 14, an audio processor 32, a second buffer 18, a digital to analog converter 20, a first buffer 38, an IEC burst circuit 22, and a digital interface 24. The audio processor 32 includes a decoding circuit 34 and a stream recovering circuit 36. That is, both the decoding circuit 34 and the stream recovering circuit 36 are integrated into the audio processor 32. When an optical storage disk 26 is loaded into the optical disk drive, digital data previously recorded on the optical storage disk 26 is read and preliminarily processed by a servo controller (which is not shown in FIG. 3). The digital data preliminarily processed is parsed by the parser 12 and then the audio part of the digital data is outputted in the form of a first stream complying with a first standard (for example, MPEG audio standard) and stored in the stream buffer 14. The first stream includes a plurality of audio frames. Each of the audio frames includes a plurality of fields. The decoding circuit 34 of the audio processor 32 decodes the audio frames of the first stream stored in the stream buffer 14, generates a PCM (pulse-code modulation) encoded stream and stores the PCM encoded stream in the second buffer 18. The digital to analog converter 20 converts the PCM encoded stream stored in the second buffer 18 into an analog audio signal as an output signal of the optical disk drive. This embodiment provides the previously mentioned normal audio processing function as well, but the data conversion function using the digital interface 24 for connecting to an external post-stage audio receiver 28 is modified. First, the audio processing circuit 30 uses the stream recovering circuit 36 of the audio processor 32 to detect the audio frames of the first stream stored in the stream buffer 14 and to modify (to fix) the audio frames of the first stream according to a first standard (for example, an MPEG audio standard). And then, the frames detected or modified by the stream recovering circuit 36 are stored in the first buffer 38. Finally, the IEC burst circuit 22 converts the modified frames into a second stream complying with a second standard (for example, an IEC digital interface standard, which is also called S/PDIF standard) and sends the second stream to the post-stage audio receiver 28 through the digital interface 24. In more details, the IEC burst circuit 22 in FIG. 3 retrieves the modified frames stored in the first buffer 38 and partitions the modified frames into payload sections of proper sizes. The corresponding preamble is then added in front of each payload to form a data burst section. The corresponding stuffing section (including several stuffing bits) is then added next to each data burst section. The second stream complying with the S/PDIF standard is thus formed and sent to the post-stage audio receiver 28 through the digital interface 24.

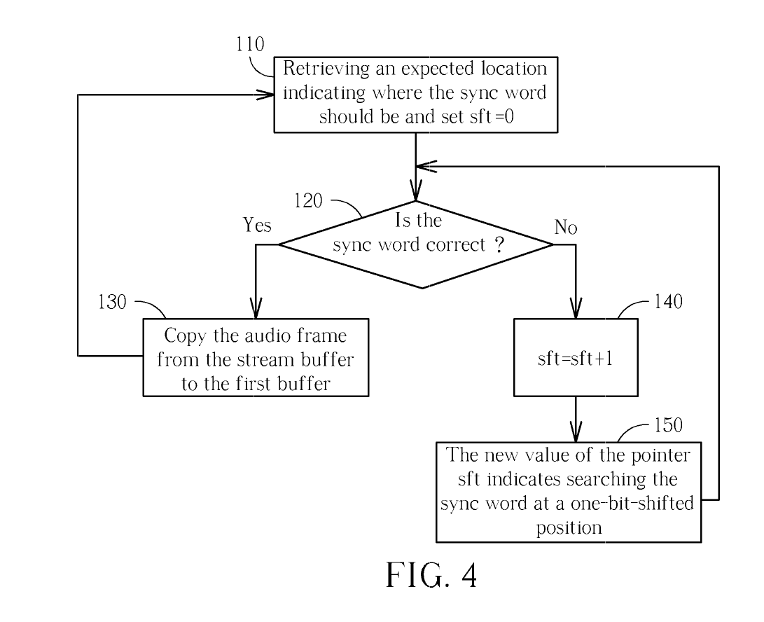

FIG. 4 illustrates a flowchart for detecting and modifying streams with the audio processing circuit 30 of FIG. 3. The first stream (for example, an MPEG audio bit stream) includes a plurality of audio frames, and each audio frame includes a sync word at the beginning of the audio frame for data partitioning. The sync word of each audio frame has a unique pattern, for example, 0xfff in the MPEG audio bit stream. The expected position of the sync word is implied in the first stream. However, for some streams encoded by an improper audio encoding mechanism, the positions of the sync words may not reside in the expected position as implied in the streams. Instead, the actual positions of the sync words may be shifted to neighboring positions near the expected positions. A conventional audio processing circuit (such as those illustrated in FIG. 2) does not check whether the actual positions of sync words match the expected positions (i.e. whether the positions of the sync words are shifted), and simply partitions the frames of the first stream as if the sync words do reside in the expected positions, and forming the second stream to the decoding/amplifying device 28 (the post-stage audio receiver 28) via the digital interface 24 (for example, an IEC digital interface). In such a circumstance, when the decoding/amplifying device 28 (the post-stage audio receiver 28) receives the second stream and tries to recover it back to the first stream, it may improperly (or even fail to) decode the second stream and/or the first stream because the partitioning of the first stream is incorrect, and a blast sound may occur. In order to prevent errors due to the above mentioned sync word shift, the audio processing circuit 30 of this embodiment uses the stream recovering circuit 36 of the audio processor 32 to detect the audio frames of the first stream stored in the stream buffer 14 and to modify (to recover) the audio frames of the first stream according to the predetermined first standard (for example, MPEG audio standard). The audio frames of the first stream are detected and modified by the stream recovering circuit 36, and are then stored in the first buffer 38. Finally, the IEC burst circuit 22 transfers the modified frames into a second stream complying with a second standard (for example, the IEC digital interface standard) and sends the second stream to the post-stage audio receiver 28 through the digital interface 24 (for example, the IEC digital interface). The steps for detection and modification are described as follows.

Step 110: Retrieving an expected location indicating where the sync word should be in the bit stream buffer 14, set the value of a pointer sft as zero, and then go to Step 120;

Step 120: Is the sync word correct? If the value at the expected location matches a predetermined pattern (ex. 0xfff in this embodiment), go to Step 130, if not, go to Step 140;

Step 130: Copy the audio frame having its beginning pointed by the pointer sft from the stream buffer 14 to the first buffer 38 to complete the detection and the modification of the frame, and then go to Step 110 for further detection and modification of the next audio frame;

Step 140: Set a new value of the pointer sft. The new value equals to the previous value of the pointer sft plus one. This step represents that the expected position is modified by one bit. Go to Step 150; and

Step 150: The new value of the pointer sft indicates searching the sync word at a one-bit-shifted position. Now a bit at the leftmost end (i.e. MSB, Most Significant Bit) corresponding to the expected location is omitted, and a next bit of the first stream is added at the rightmost end (i.e. LSB, Least Significant Bit) corresponding to the expected location. Go back to Step 120.

Although the shift direction in Step 150, as a result of Step 140, can be derived from the statement about the omitted bit at the leftmost end and the added bit at the rightmost end, this is not limiting. The shift direction is just an exemplary choice relating to the logical direction definition of the stream buffer 14. As the original MSB mentioned in Step 150 can be omitted first and each bit can be replaced with the next bit, whether the shift direction is left or right does not hinder the implementation of this invention. Through the process of these steps (Step 110, 120, 130, 140, 150), the above-mentioned undesired shifted state of the data of the audio frames is corrected and the modified frames stored in the first buffer 38 are ready for partitioning into proper payload sections according to the S/PDIF standard. As previously mentioned, the IEC burst circuit 22 converts the modified frames stored in the first buffer 38 into a second stream complying with the second standard (for example, the S/PDIF standard) and sends the modified frames to the post-stage audio receiver 28 through the digital interface 24. Therefore, the compatibility between the audio processing circuit 30 and the decoding/amplifying device 28 (the post-stage audio receiver 28) is enhanced.

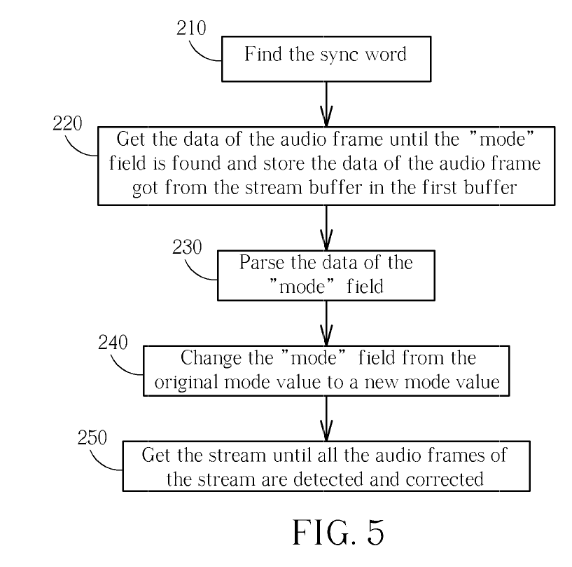

FIG. 5 illustrates a flowchart for changing a specific field in a stream with the audio processing circuit 30 in FIG. 3. Under certain conditions, the decoding/amplifying device 28 (the post-stage audio receiver 28) cannot properly decode the audio bit stream because it does not recognize a specific field in the bit stream. By changing a specific field in the original audio bit stream (retrieved from the optical storage disk 26) with the audio processing circuit 30, the problem can be solved and the decoding/amplifying device 28 (the post-stage audio receiver 28) can properly decode the audio bit stream. For example, in an MPEG audio signal, there is a two-bit “mode” field identifying a playback mode of the audio signal. The playback modes usually include a “mono” mode, a “dual mono” mode, and a “stereo” mode, where the “mono” mode represents reproducing a sound content with one audio channel, and the “dual mono” mode and the “stereo” mode represent reproducing different sound contents with two audio channels so there are stereo effects to the listeners. Some decoding/amplifying devices 28 (the post-stage audio receivers 28) do not recognize the “dual mono” mode. This type of decoding/amplifying devices 28 can correctly reproduce one audio channel at the “mono” mode and can also correctly reproduce two audio channels at the “stereo” mode, but will simply reproduce one audio channel at the “dual mono” mode. The listener would easily perceive the problem of the incompatibility between the decoding/amplifying device 28 (the post-stage audio receiver 28) and the optical disk drive. In this embodiment, the audio processing circuit 30 can use the stream recovering circuit 36 of the audio processor 32 to change a value of the “mode” field of the audio bit stream (retrieved from the optical storage disk 26) from an original value of “dual mono” mode to a new value of “stereo” mode, so the “stereo” mode decoding method of the decoding/amplifying device 28 (the post-stage audio receiver 28) is selected. Therefore, the decoding/amplifying device 28 can reproduce the “dual mono” mode data retrieved from the optical storage disk 26 at the “stereo” mode. As most of decoding/amplifying devices 28 (post-stage audio receivers 28) can recognize the “stereo” mode, the problem of the incompatibility between the decoding/amplifying devices 28 and the optical disk drive due to above mentioned problem is solved. The process of changing a field in the original stream, the first stream, retrieved from the optical storage disk 26 with the audio processing circuit 30 is described as follows.

Step 210: Find the sync word in the stream buffer 14;

Step 220: Get the data of the audio frame of the first stream from the stream buffer 14 until the “mode” field is found and store the data of the audio frame got from the stream buffer 14 in the first buffer 38, where “Get” is a programming term representing an action of “retrieving” or “receiving”;

Step 230: Parse the data of the “mode” field received from the stream buffer 14;

Step 240: Change the “mode” field from the original mode value to a new mode value;

Step 250: Get the stream until all the audio frames of the stream are detected and corrected;

Of concern, “Get”, the programming term representing an action of “retrieving” or “receiving” in the above steps (Step 220, 250), can be replaced by other terms while the implementation of the present invention is not hindered. In addition, although in this embodiment the field data to be changed is a single value, this is not limiting. For example, the data to be changed can be a plurality of values or even data of a plurality of fields. This leads to embodiments relating to copyright management. In some audio signals, there is a “copyright” field indicating the copyright management information of the audio signal. The copyright management information generally includes “no copy”, “copy always”, and “copy once”. When the “copyright” field of the stream retrieved from the optical storage disk 26 is recorded as “no copy”, the content (ex. video or audio data) recorded on the optical storage disk 26 is read-only and cannot be copied to any other digital storage devices (ex. other optical disks, mini disks, flash memory drives, hard drives, etc.). One embodiment is described as follows. When the “copyright” field of the stream retrieved from the optical storage disk 26 is recorded as “copy always”, the content (ex. video or audio data) recorded on the optical storage disk 26 can be copied as many times as desired without limitation. When the “copyright” field of the stream retrieved from the optical storage disk 26 is recorded as “copy once”, the stream recovering circuit 36 of the audio processor 32 in this embodiment will change the “copyright” field in the content recorded on the optical storage disk 26 from “copy once” to “no copy” after one copy process is done.

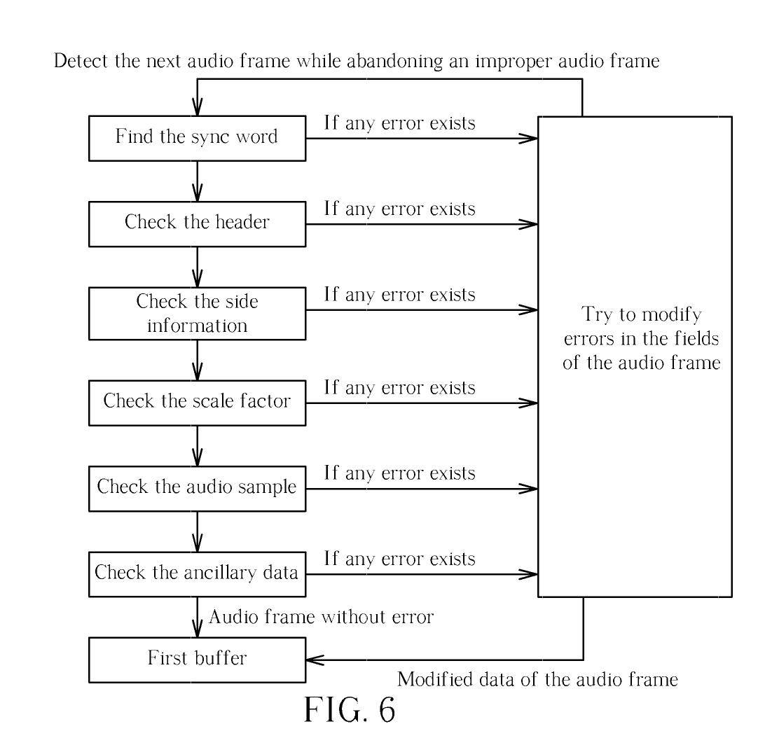

FIG. 6 illustrates a flowchart of detecting and modifying errors of a stream with the audio processing circuit 30 in FIG. 3. Another function of the stream recovering circuit 36 of the audio processor 32 is detecting the audio frames of the first stream received from the stream buffer 14 and modifying the content in at least one field of the audio frames as needed. The stream recovering circuit 36 can detect if there is any error in various fields of the audio frames in the first stream) and modify the first stream according to a predetermined digital audio standard if modification is required. After the audio processing circuit 30 uses the parser 12 to receive the first stream retrieved from the optical storage disk 26 and stores the first stream in the stream buffer 14, the stream recovering circuit 36 checks each field of the first stream. As shown in FIG. 6, the stream recovering circuit 36 first finds the sync word of the first stream in the stream buffer 14, and then checks the fields one by one, where the fields include the “sync word” field, “header” field, the “side information” field, the “scale factor” field, the “audio sample” field, and the “ancillary data” field. If the first stream is completely correct, the first stream is stored in the first buffer 38. If the content of any field is detected to be in error by the stream recovering circuit 36, the stream recovering circuit 36 will try to modify the field to recover a correct format of the stream according to a predetermined digital audio standard (for example, MPEG audio standard). If the stream recovering circuit 36 successfully corrects the fields, the modified fields are stored in the first buffer 38. As shown in FIG. 6, the stream recovering circuit 36 will check the next field until each field is verified. If the stream recovering circuit 36 fails to correct the field during any iteration of the field data correction, the current frame is abandoned and the stream recovering circuit 36 detects the next frame and repeats the process shown in FIG. 6. That is to say, the stream recovering circuit 36 modifies the first stream received from the stream buffer 14 to conform with the predetermined digital audio standard (for example, MPEG audio standard) by correcting errors in the fields of the first stream. When the stream recovering circuit 36 is unable to correct some frames of the first stream received from the stream buffer 14, the stream recovering circuit 36 abandons the uncorrectable frames which are not capable of being modified to conform with the predetermined standard. In this way, the stream recovering circuit 36 will not allow frames with uncorrectable errors to pass onwards. So there could probably be a short period of silence to the listeners when there are frames with uncorrectable errors in the first stream. However, considering the characteristic of the decoding/amplifying device 28 (the post-stage audio receiver 28) and the listeners' comforts, no sound is better than blast sound because ordinary human ears could not perceive such a short period of silence.

As previously mentioned, the audio processing circuit 30 of the present invention provides the ordinary audio decoding function to reproduce the digital data retrieved from the optical storage disk 26 and further provides the stream recovering circuit 36 for processing the frames of the stream stored in the stream buffer 14. The functions of the stream recovering circuit 36 include correcting the sync word shift, modifying the data contents of the stream, detecting (checking) the data contents of the stream, and trying to recover a correct format of the data content of the stream. The frames of the stream processed by the stream recovering circuit 36 of the audio processor 32 are stored in the first buffer 38. The IEC burst circuit 22 then arranges the modified frames or verified frames stored in the first buffer 38 (for example, the arrangement includes adding the preambles and stuffing bits to form a second stream complying with the S/PDIF standard) and sends the second stream to the post-stage audio receiver 28 through the digital interface 24 (for example, S/PDIF interface). Therefore, the compatibility between the audio processing circuit 30 and the decoding/amplifying device 28 (the post-stage audio receiver 28) is enhanced.

In contrast to the prior art, the present invention method and device can use the stream recovering circuit 36 of the audio processor 32 to properly detect and modify the stream retrieved from the optical storage disk 26 and use the IEC burst circuit 22 to arrange the modified audio frames of the first stream stored in the first buffer 38 so that the compatibility between the audio processing circuit 30 and the external decoding/amplifying device 28 (the post-stage audio receiver 28) is enhanced. Adapting to the post-stage audio receiver 28 through the digital interface 24, the audio processing circuit 10 of the prior art simply uses the IEC burst circuit 22 to transfer the audio frames of the first stream stored in the stream buffer 14 into the second stream without checking the content of the audio frames, so the audio frames which are not completely compliant with a predetermined digital audio standard will be output to the post-stage audio receiver 28 through the digital interface 24. Hence when the post-stage audio receiver 28 receives the second stream derived from the audio frames of the first stream that is not completely compliant with the predetermined digital audio standard (for example, MPEG audio standard), the post-stage audio receiver 28 may improperly or even fail to decode the received second stream and/or the first stream, and a blast sound may occur. Adapting to the post-stage audio receiver 28 through the digital interface 24, the audio processing circuit 30 of the embodiment uses the stream recovering circuit 36 of the audio processor 32 to process the audio frames of the first stream stored in the stream buffer 14 and stores the audio frames processed by the stream recovering circuit 36 in the first buffer 38. The IEC burst circuit 22 then arranges the modified audio frames stored in the first buffer 38 to form a second stream complying with a second standard (for example, the S/PDIF standard) and sends the second stream to the post-stage audio receiver 28 through the digital interface 24. Therefore, the audio processing circuit 30 can remove the frames with errors and/or can modify the frames which are not completely compliant with a predetermined digital audio standard (for example, the MPEG audio standard), so the decoding/amplifying device 28 (the post-stage audio receiver 28) can correctly decode the data of the digital audio signal and the compatibility is therefore enhanced.

Those skilled in the art will readily observe that numerous modifications and alterations of the device may be made while retaining the teachings of the invention. For example, in the above embodiments the first stream complies with the MPEG audio standard and the second stream complies with the S/PDIF standard (IEC digital interface standard). This is not limiting. Instead, the present invention should be construed as limited only by the metes and bounds of the appended claims.

What is claimed is:

1. An audio processing circuit for receiving a first stream complying with a first standard and generating a second stream complying with a second standard which is a digital interface standard, the first stream includes a plurality of frames, each of the frames includes a plurality of fields, the audio processing circuit comprises:
a stream buffer for storing the frames of the first stream;
a stream recovering circuit electrically connected to the stream buffer for receiving the first stream having a mode field, the candidate values of the mode field in the first standard at least comprising a dual mono mode and a stereo mode, and for processing the first stream to generate the second stream so that the mode field of the second stream is the stereo mode value if the mode field of the first stream contains the dual mono mode value; and
a digital interface for outputting the second stream to a post-stage audio receiver.

2. The audio processing circuit of claim 1, wherein the dual mono mode and the stereo mode represent reproducing different sound contents with two audio channels.

3. The audio processing circuit of claim 1, wherein the post-stage audio receiver does not recognize the dual mono mode.

4. The audio processing circuit of claim 1, wherein the second standard is S/PDIF standard.

5. The audio processing circuit of claim 1, wherein the first stream is retrieved from an optical disk.

6. The audio processing circuit of claim 1, wherein the first stream complies with MPEG audio standard.

7. The audio processing circuit of claim 1, wherein the second stream complies with IEC61937/IEC60958 standards.

8. A method for converting a first stream complying with a first standard into a second stream complying with a second standard which is a digital interface standard, the first stream includes a plurality of frames, each of the frames includes a plurality of fields, the method comprises the steps of:
receiving the first stream having a mode field with a stream recovering circuit, the candidate values of the mode field in the first standard at least comprising a dual mono mode and a stereo mode;
processing the first stream to generate the second stream with the stream recovering circuit so that the mode field of the second stream is the stereo mode value if the mode field of the first stream contains the dual mono mode value; and
outputting the second stream with a digital interface to a post-stage audio receiver.

9. The method of claim 8, wherein the dual mono mode and the stereo mode represent reproducing different sound contents with two audio channels.

10. The method of claim 8, wherein the post-stage audio receiver does not recognize the dual mono mode.

11. The method of claim 8, wherein the second standard is S/PDIF standard.

12. The method of claim 8, wherein the first stream is retrieved from an optical disk.

13. The method of claim 8, wherein the first stream complies with MPEG audio standard.

14. The method of claim 8, wherein the second stream complies with IEC61937/IEC60958 standards.

15. An optical disk drive, comprising:
a parser for parsing a first stream from an optical disk;
a stream buffer for storing frames of the first stream;
a stream recovering circuit electrically connected to the stream buffer for receiving the first stream having a mode field, the candidate values of the mode field in the first standard at least comprising a dual mono mode and a stereo mode, and for processing the first stream to generate a second stream so that the mode field of the second stream is the stereo mode value if the mode field of the first stream contains the dual mono mode value, the second stream being a digital interface standard; and
a digital interface for outputting the second stream to a post-stage audio receiver.

16. The optical disk drive of claim 15, wherein the dual mono mode and the stereo mode represent reproducing different sound contents with two audio channels.

17. The optical disk drive of claim 15, wherein the post-stage audio receiver does not recognize the dual mono mode.

18. The optical disk drive of claim 15, wherein the second standard is S/PDIF standard.

19. The optical disk drive of claim 15, wherein the first stream is retrieved from an optical disk.

20. The optical disk drive of claim 15, wherein the first stream complies with MPEG audio standard.

21. The optical disk drive of claim 15, wherein the second stream complies with IEC61937/IEC60958 standards.
